(19) United States
(12) Patent Application Publication
(10) Pub. No.: US 2002/0080956 A1
(43) Pub. Date: Jun. 27, 2002

(54) Interface device for data communication in analog exclusive line

(75) Inventor: Ha Kyoon Lim, Kyonggi-do (KR)

Correspondence Address: Jonathan Y. Kang, Esq., Lee & Mong P.C., 11th Floor, 221 N. Figueroa Street, Los Angeles, CA, 90012-2001, US

(73) Assignee: LG Electronics Inc.

(21) Appl. No.: 09/898,285

(22) Filed: Jul. 2, 2001

(30) Foreign Application Priority Data
Dec. 21, 2000 (KR) 2000-79753

(51) Int. Cl. H04M 7/04; H04M 9/00

(52) U.S. Cl. 379/398

(57) ABSTRACT

An interface device for transmitting data for data communication in an analog exclusive line includes a modem unit for modulating data, an impedance matching unit for matching an impedance with the analog exclusive line, an FXS signal unit for recognizing a connection request signal from an FXO interface, a hybrid 2:4 wire conversion unit for converting a four wire interface from the modem unit into a two wire interface for the analog exclusive line, and a main processor. The FXS signal unit uses the analog exclusive line which does not have an exchange, and thus performs the data communication as in the PSTN. The modem unit is informed of the connection request signal from another device by a local ring generating unit.

### CROSS REFERENCE TO RELATED ART

This application claims the benefit of Korean Patent Application No. 2000-79753, filed on Dec. 21, 2000, which is hereby incorporated by reference in its entirety.

### BACKGROUND OF THE INVENTION

1. Field of the Invention

The present invention relates to an interface device used for data communication in an analog exclusive line, and in particular, to an improved device for transmitting data which can support a foreign exchange station (FXS) interface, replacing an exchange in the communication between exclusive lines which do not have a special exchange.

2. Discussion of the Related Art

FIG. 1 is a schematic block diagram illustrating a conventional interface device for transmitting data, which supports a public switched telephone network (PSTN). Referring to FIG. 1, the conventional device for transmitting data includes a main processor unit 10, a modem unit 11, a ROM unit 12, a memory unit 13, an impedance matching unit 14, an off-hook switch detector/2:4 wire conversion unit 15, and a ring sensing unit 16.

The modem unit 11 modulates serial or parallel data from the main processor unit 10 in a voice band of 4 Khz according to a predetermined modulation method, and demodulates received data. The ROM unit 12 stores an initial code for the modem unit 11 and a control program for the modem operation. The memory unit 13 stores data for the current operation of the modem unit 11 among the data stored in the ROM unit 12, and thus enables the modem unit 11 to access the data at a high speed. The impedance matching unit 14 matches impedance with the PSTN by supplying impedance matching of 600 Ohms.

When the modem unit 11 demands a call path setup for data transmission, the off-hook switch detector/2:4 wire conversion unit 15 turns off a switch to connect the device for transmitting data to the PSTN 17. When the call is terminated, the off-hook switch unit/2:4 wire conversion unit 15 turns on the switch to disconnect the device for transmitting data from the PSTN 17. In addition, the off-hook switch detector/2:4 wire conversion unit 15 converts a four wire interface from the modem unit 11 into a two wire interface. The ring sensing unit 16 senses a ring alarm signal from the exchange and notifies a call request by ringing.

The operation of the conventional interface device for transmitting data, which supports the PSTN, will now be explained. The modem unit 11 supports an FXO interface and the exchange supports an FXS interface, such as a power supply or a ring signal transmission. The modem unit 11 is connected to the PSTN 17, for modulating data in a voice band of 4 Khz through the FXO interface.

The transmission process of the conventional interface device for transmitting data will now be described. The modem unit 11 should be connected to the PSTN 17 to transmit data. The modem unit 11 transmits a data terminal ready (DTR) signal to the main processor unit 10, and the main processor unit 10 transmits a data set ready (DSR) signal to the modem unit 11 as a response signal, thereby finishing the initial operation for connection to the PSTN 17.

Thereafter, the modem unit 11 commands the off-hook switch detector/2:4 wire conversion unit 15 to switch off a telephone line to which the modem unit 11 and the PSTN 17 are connected, using the AT command of the Hayes standard communication language. In the off-hook state, the modem unit 11 is ready to transmit a call request signal to the other party through the PSTN.

When receiving the call request signal according to a predetermined dial pulse or a dialing such as dual tone multi frequency (DTMF), the exchange performs an FXS interface function for transmitting a ring alarm signal to the other party.

When the call path is formed between two devices, the modem unit 11 examines a line state and exchanges compression and error correction methods with the connected modem. The procedure of exchanging the compression or error correction method before the real data communication is described as hand-shaking or negotiation. When the hand-shaking is finished, the data communication is performed.

The reception process of the conventional device for transmitting data will now be described. When the ring signal is transmitted from the exchange to the device for transmitting data through the PSTN, the ring sensing unit 16 senses the ring signal and notifies the call request to the modem unit 11. The modem unit 11 automatically or manually recognizes a signal from the ring sensing unit 16, and thus converts the off-hook switch into a data line. When the call path is formed between the two devices, the hand-shaking is performed and the data communication is started.

The conventional device for transmitting data is used mainly in the PSTN through the FXO interface. However, the device does not include the FXS interface, and thus is not suitable for the voice analog exclusive line, which does not have an exchange.

### SUMMARY OF THE INVENTION

Accordingly, the present invention is directed to an exchange interface device for data communication using an analog line that substantially obviate one or more of the problems due to limitations and disadvantages of the related art.

It is an object of the present invention to provide an exchange interface for data communication in an analog exclusive line by supporting a foreign exchange station (FXS) interface.

It is another object of the present invention to provide a device for transmitting data for data communication in an analog exclusive line which can notify a call request signal to a modem by local ring generation for a flexible interface, without requiring a special ring generating device.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve at least the above objects in whole or in parts, there is provided a device for transmitting data for data communication in an analog exclusive line, including: a modem unit for modulating data according to a predetermined modulation method, transmitting the modulated data to the other modem, demodulating data from the other modem, and transmitting the demodulated data to a main processor unit; a memory unit for storing an initial code and control program for the operation of the modem unit, and supporting high-speed access to the necessary data; an impedance matching unit for matching an impedance with the analog exclusive line; an FXS signal unit for recognizing a connection request signal from an FXO interface and supplying operation power; a hybrid 2:4 wire conversion unit for converting a four wire interface from the modem unit into a two wire interface for the analog exclusive line; and a main processor unit for providing data to the modem unit to be transmitted to the other modem, receiving the demodulated data from the modem unit, and controlling the operation of the modem unit and the FXS interface unit.

The FXS signal unit forms a closed circuit with the FXO interface attempting connection, and senses the connection request of the FXO interface by sensing a loop current flowing through the closed circuit.

In addition, the device for transmitting data further includes an local ring generating unit. It notifies the connection request signal of the FXO interface to the modem unit by transmitting a virtual ring alarm signal to the modem unit, when the FXS interface senses the connection request signal. According to another aspect of the present invention, the ring alarm signal is internally simulated by using a programmable chip.

It is to be understood that both the foregoing general description and the following detailed description are exemplary and explanatory and are intended to provide a further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and, together with the description, serve to explain the principles of the invention.

FIG. 1 is a schematic block diagram illustrating a conventional interface device for transmitting data which supports a public switched telephone network (PSTN);

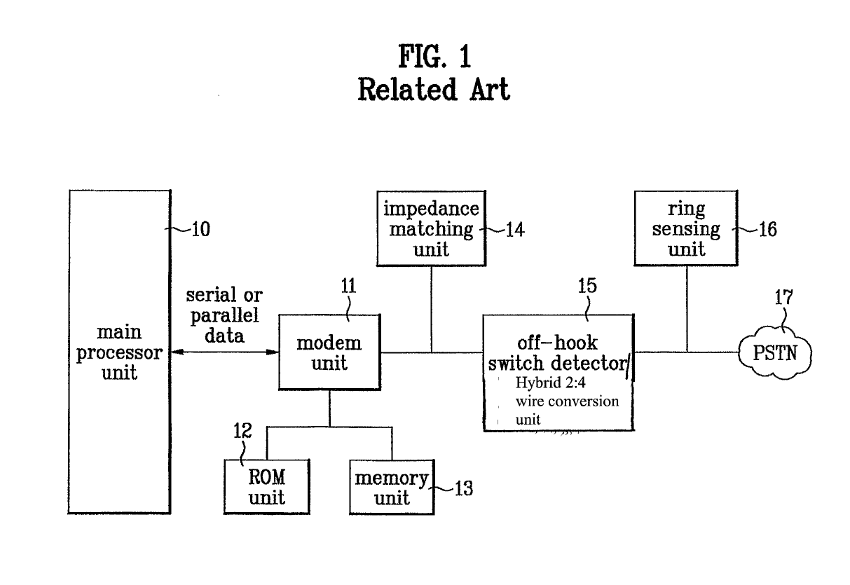

FIG. 2 is a schematic block diagram of the interface device for data communication in an analog exclusive line in accordance with a preferred embodiment of the present invention;

FIG. 3 is a functional block diagram of the local ring generating unit of the interface device according to the preferred embodiment;

FIG. 4 is a flow diagram for connecting calls using the analog exclusive line according to the preferred embodiment of the present invention; and

FIG. 5 is a system wide block diagram illustrating the connections between a plurality of telephones using the interface device according to the present invention and the analog line.

### DETAILED DESCRIPTION OF THE PREFERRED EMBODIMENTS

A device for transmitting data for data communication in an analog exclusive line in accordance with a preferred embodiment of the present invention will now be described in detail with reference to the accompanying drawings.

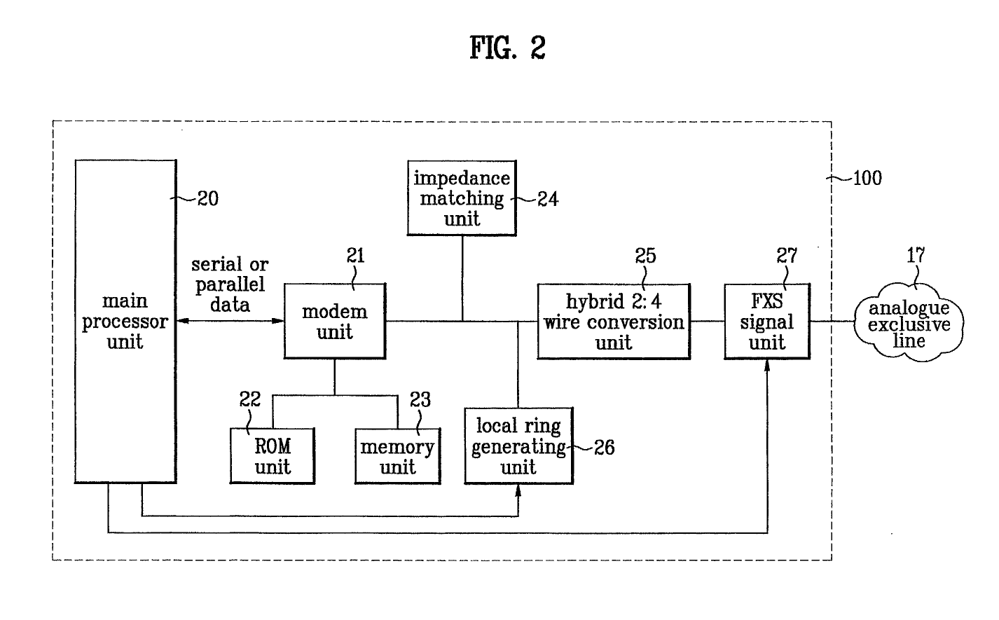

FIG. 2 is a schematic block diagram illustrating the device for transmitting data for data communication in the analog exclusive line in accordance with the preferred embodiment of the present invention.

As illustrated in FIG. 2, the device for transmitting data includes a main processor unit 20, a modem unit 21, a ROM unit 22, a memory unit 23, an impedance matching unit 24, a hybrid 2:4 wire conversion unit 25, an local ring generating unit 26, and an FXS signal unit 27.

The modem unit 21 modulates serial or parallel data from the main processor unit 20 in a voice band of 4 Khz according to a predetermined modulation method, demodulates data received through the exclusive line, and transmits the demodulated data to the main processor unit 20.

The ROM unit 22 stores an initial code for the modem unit 21 and a control program for the modem operation. The memory unit 23 stores data for the current operation of the modem unit 21 among the data stored in the ROM unit 22, and thus enables the modem unit 21 to access the data at a high speed.

The impedance matching unit 24 matches an impedance of the device with the impedance of the analog exclusive line to reduce impedance mismatching that causes degradation in transmission performance. The impedance of the analog exclusive line is 600 Ohms, which is identical to the PSTN.

On the other hand, a signal is transmitted through two transmission and reception lines (i.e., a twisted pair line) in the analog exclusive line 28, but transmitted through four transmission (+,−) and reception (+,−) lines in the modem unit 21. Accordingly, the hybrid 2:4 wire conversion unit 25 converts a signal from two lines to be transmitted to four lines. The hybrid 2:4 wire conversion unit 25 is well known to one of ordinary skill in the art and therefore will not be described herein for the sake of brevity.

The local ring generating unit 26 internally simulates a ring signal, instead of an external ring generating device. In the case of the PSTN, the exchange includes a ring generating device. Therefore, when receiving a call request signal, the ring generating device transmits a signal of 20 Hz and 90 Vrms to the device for transmitting data. If the modem receives the ring alarm signal, a voltage of 90 Vrms may adversely influence the device due to inherently high voltage. Accordingly, the interface device converts the ring alarm signal into 5 V, and transmits the resultant signal to the modem unit. The modem unit sets up a call path with the other party through the PSTN.

In contrast, the interface device 100 according to the preferred embodiment of the present invention relates to one to one communication through an exclusive analog line, and thus does not include an exchange. When the device receives a call request from the other device, the two devices are directly connected without using a ring alarm signal. To install the ring generating device in such a network consumes much power and is expensive. In accordance with the preferred embodiment of the present invention, the interface device 100 includes the local ring generating unit 26 for generating a virtual ring alarm signal of 5V and 20 Hz and for transmitting the signal to the modem unit, which obtains the same effect as the ring alarm signal of the exchange. Preferably, the ring alarm signal is generated by using a programmable chip, such as ASIC (Application Specific Integrated Circuit).

The FXS signal unit 27 provides the FXS interface and power to the device for transmitting data. When the interface device 100 attempts an off-hook, the FXS signal unit 27 is operated in the same manner as the exchange of the PSTN sensing the off-hook state and forming the call path. In addition, when the device is supplied with a high voltage, for example, due to lightning, the FXS signal unit 27 senses and prevents such a high voltage. The main processor unit 20 controls the operation of the modem unit 21, the local ring generating unit 26 and the FXS signal unit 27.

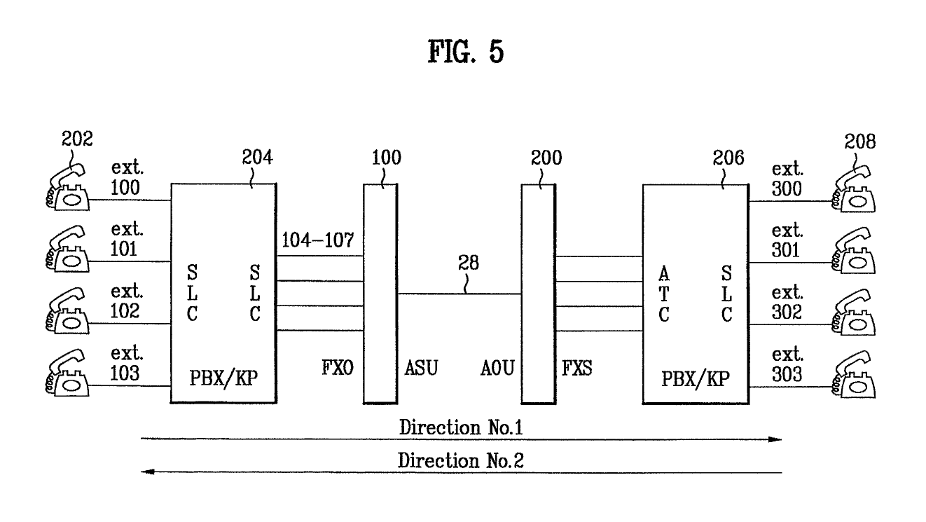

Referring to FIG. 5, the operation of the device for transmitting data for data communication using an analog exclusive line will now be explained. There are first interface device 100 (FXO interface device) and second interface device 200 (FXS interface device) devices connected through the analog exclusive line. The FXO and FXS interface devices 100 and 200 are identical devices and are interchangeably used. The FXO interface device 100 attempts the off-hook to connect the two devices. Preferably, when the FXO interface device attempts the off-hook, the switch is closed to form a closed circuit with the FXS signal unit 27 of the second interface device 200. When the closed circuit is formed by attempting the off-hook, a loop current flows in the formed loop. The FXS signal unit 27 senses the loop current and recognizes the connection of the FXO interface device 100 and the FXS interface device 200.

The FXS signal unit 27 sensing the loop current notifies the connection attempt of the FXO interface device 100 (e.g., the first interface device) to the local ring generating unit 26 of the second interface device 200. The local ring generating unit 26 generates the virtual ring alarm signal, and transmits the signal to the modem unit 21. As described above, the virtual ring alarm signal is preferably simulated by using the programmable logic. In order to obtain the same effect as the external ring signal (received from the outside network), the ring alarm signal has 16 Hz to 50 Hz (generally 20 Hz) and 5V.

The modem unit 21 of the second interface device 200 receiving the ring alarm signal recognizes the connection attempt of the other party, and performs the hand-shaking with the other modem. In the hand-shaking procedure, the two modems decide a compression method and a line probing transmission speed and error correction method, and then the two modems are connected to each other.

When the modem connection and the hand-shaking are finished, the data communication is performed between the two devices. In the case of the data transmission, the main processor unit 20 transmits the data to the modem unit 21. The modem unit 21 modulates the received data in a voice band of 4 Khz according to the predetermined modulation method known to one of ordinary skill in the art, and transmits the modulated data to the other modem. In the case of the data reception, the modem unit 21 receives the modulated data from the other modem, demodulates the received data, and transmits the demodulated data to the main processor unit 20 in series or parallel.

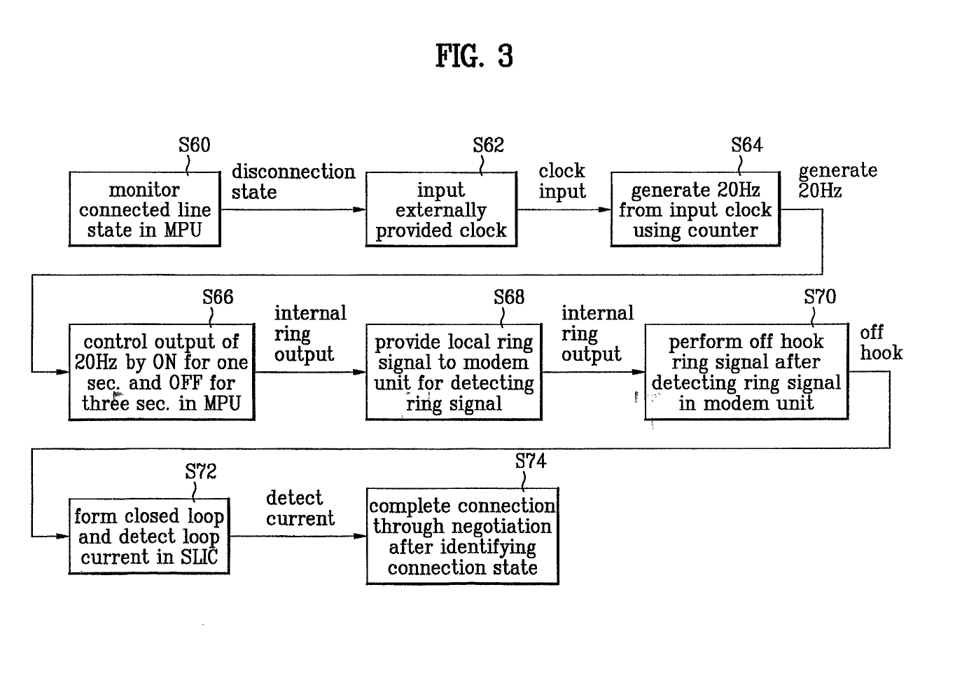

FIG. 3 is a functional block diagram of the local ring generating unit 26 of the interface device 100 (the FXO interface device and the FXS interface device shown in FIG. 5) according to 30 the preferred embodiment. First, the local ring generating unit 26 checks the line status connected to the main processor unit 20 in step S60. When the line status constitutes a cut-off status, the local ring generating unit 26 receives a clock signal from external sources in step S62. Thereafter, using the inputted clock signal, the local ring generating unit 26 generates and outputs a 20 Hz signal in step S64.

When the main processor unit 20 generates 20 Hz signal, the local ring generating unit 26 controls such signal to be on for about one second and off for about 3 seconds in step S66 and outputs such controlled signal to the modem unit 21 in step S68. Upon detecting the ring signal, the modem unit 21 generates a signal constituting the off-hook status in step S70.

Detection of the presence of current flow in the loop is observed by the SLIC device in step S72. Upon verifying the connection between the telephones, the interface device 100 connects the calls in step S74.

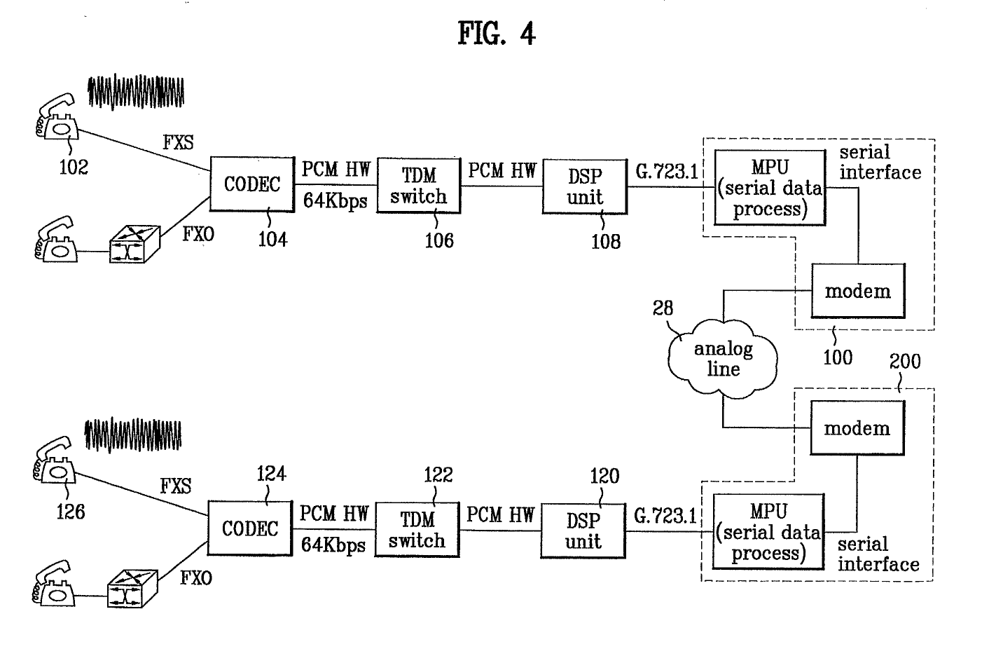

FIG. 4 is a flow diagram for connecting calls using the analog exclusive line according to the preferred embodiment of the present invention. Referring to FIG. 4, a call is made from a telephone in communication with a codec 104. The codec 104 is an A/D converter to convert analog voice signal into a digital signal. The pulse compressed signal outputted from the codec 104 is provided to the TDM (Time Division Multiplexing) switch 106. The TDM switch 106 performs a switching operation between multiple inputs and transmits the processed data to the DSP unit 108. The DSP (Digital Signal Processing) unit 108 compresses the input data according to a predetermined algorithm known to one of ordinary skill in the art. For example, the G.723.1 protocol may be used in the DSP unit 108. The output of the DSP unit 108 is then provided to the first interface device 100 (shown in detail in FIG. 2) which is in communication with the analog line 28.

A second interface device 200 (which is identical to the first interface device 100) is also in communication with the analog line 28 and receives the data transmitted from the first interface device 100. The output of the second interface device 200 is provided to a remote DSP 120 which decompresses the data using the same protocol, such as G.723.1, used in the first DSP unit 108. The output of the DSP unit 120 is then provided to a TDM switch 122 which then routes the signal to the codec 124 to convert the digital signal into analog signal. The analog signal is then provided to a remote telephone 126.

FIG. 5 is a system wide block diagram illustrating the connections between a plurality of telephones using the interface device according to the present invention and the analog line. FIG. 5 shows two different call paths using the interface device of the present invention. Direction No. 1 illustrates a call made within the same system, such as calling one extension from another extension using only the extension number. Direction No. 2 illustrates a call made through an outside network, such as calling outside of the internal call network by dialing, for example, “9” to obtain an outside access line (trunk access).

When a call is made in Direction No. 1 (for example, an internal call) using a telephone 202 having extension no. 100, the telephone user dials, for example, extension no. 300. The first exchanger 204, such as PBX, converts the extension no. 300 into an internally recognizable extension, for example extension no. 104 and signals the first interface device 100 of the present invention. The interface device 100 uses the analog exclusive line 28 to reach a second interface device 200 (same as the first interface device 100). The second interface device 200 transmits the call to the second exchanger 206 and connects the telephone 208 with extension no. 300 with the telephone 202.

When a call is made in Direction No. 2 (for example, an external call) using a telephone 208 having extension no. 300, the telephone user first dials an outside access (also known as trunk access) code or number, such as “9” and dials extension number 103. A remote exchanger 204 may be reached through the first interface device 100 by closing the loop. A ring signal is generated from the first interface device 100 to connect the telephone designated with extension number 103.

As described above, the interface device 100 includes the FXS signal unit 27 in communication with the analog exclusive line 28, which does not have an exchange, and thus performs the data communication as in the PSTN. Moreover, the modem is informed of the connection request signal from the other modem by the local ring generating unit, not the external ring generating device. As a result, power consumption can be reduced, cost can be decreased, and system operation can be stabilized.

The foregoing embodiments and advantages are merely exemplary and are not to be construed as limiting the present invention. The description of the present invention is intended to be illustrative, and not to limit the scope of the claims. Many alternatives, modifications, and variations will be apparent to those skilled in the art. In the claims, means-plus-function clauses are intended to cover the structure described herein as performing the recited function and not only structural equivalents but also equivalent structures.

What is claimed is:

1. An interface device for communicating data using an analog exclusive line with an FXO interface, the interface device comprising:
a modem unit for modulating and demodulating data;
a memory unit in communication with the modem unit for storing an initial code and a control program for operation of the modem unit;
an impedance matching unit for matching impedance with the analog exclusive line;
an FXS signal unit for recognizing a connection request signal from the FXO interface;
a hybrid 2:4 wire conversion unit in communication with the modem unit for converting a four wire interface from the modem unit into a two wire interface for the analog exclusive line; and
a main processor unit for providing data to the modem unit to be transmitted to the FXO interface, receiving the demodulated data from the modem unit, and controlling the operation of the modem unit and the FXS interface unit.

2. The interface device of claim 1, wherein the FXS signal unit forms a closed circuit with the FXO interface attempting connection, and senses a connection request of the FXO interface by sensing a loop current flowing the closed circuit.

3. The interface device of claim 1, further comprising a local ring generating unit for notifying a connection request signal of the FXO interface to the modem unit by transmitting a ring alarm signal to the modem unit when the interface device senses the connection request signal.

4. The interface device of claim 3, wherein the ring alarm signal is internally simulated by using a programmable chip.

5. An interface device for communicating data using an analog exclusive line with an FXO interface, the interface device comprising:
a modem unit for modulating and demodulating data;
an FXS signal unit for recognizing a connection request signal from the FXO interface;
a hybrid 2:4 wire conversion unit in communication with the modem unit and the FXS signal unit for converting a four wire interface from the modem unit into a two wire interface for the analog exclusive line; and
a main processor unit for providing data to the modem unit to be transmitted to the FXO interface, receiving the demodulated data from the modem unit, and controlling the operation of the modem unit and the FXS interface unit.

6. The interface device of claim 5, further comprising an impedance matching unit for matching impedance of the interface device with the analog exclusive line.

7. The interface device of claim 5, a memory unit in communication with the modem unit for storing an initial code and a control program for operation of the modem unit.

8. The interface device of claim 5, wherein the FXS signal unit senses an off-hook state and forming a call path to a designated device.

9. The interface device of claim 8, wherein the FXS signal unit senses a loop current to detect the off-hook state.

10. The interface device of claim 5, further comprising a local ring generating unit for notifying a connection request signal of the FXO interface to the modem unit by transmitting a ring alarm signal to the modem unit when the interface device senses the connection request signal.

11. The interface device of claim 5, wherein the ring alarm signal of the local ring generating unit is a 20 Hz signal.

12. The interface device of claim 6, wherein the FXS signal unit senses an off-hook state and forming a call path to a designated device.

13. The interface device of claim 12, wherein the FXS signal unit senses a loop current to detect the off-hook state.

14. The interface device of claim 13, further comprising a local ring generating unit for notifying a connection request signal of the FXO interface to the modem unit by transmitting a ring alarm signal to the modem unit when the interface device senses the connection request signal.

15. The interface device of claim 14, wherein the ring alarm signal of the local ring generating unit is a 20 Hz signal.

16. A method of generating local ring in an interface device for communicating data using an analog exclusive line with an FXO interface, the interface device comprising a modem unit for modulating and demodulating data; an FXS signal unit for recognizing a connection request signal from the FXO interface; a hybrid 2:4 wire conversion unit in communication with the modem unit and the FXS signal unit for converting a four wire interface from the modem unit into a two wire interface for the analog exclusive line; and a main processor unit for providing data to the modem unit to be transmitted to the FXO interface, receiving the demodulated data from the modem unit, and controlling the operation of the modem unit and the FXS interface unit, the method comprising the steps of:
receiving a call from an external device through the analog exclusive line;
checking whether a communication line status is a cut-off status;
receiving an external clock signal from the main processor unit when the communication line status is the cut-off status;
using the external clock signal, the local ring generating unit outputs a controlled 20 Hz ring signal;
providing the controlled 20 Hz ring signal to the modem unit;
the modem unit generating a signal constituting an off-hook state;
detecting presence of a loop current flow; and
connecting the call.

17. The method of claim 16, wherein the memory unit storing a control program for operation of the modem unit.

18. The method of claim 16, wherein the FXS signal unit sensing the off-hook state and forming a call path to a designated device.

19. The method of claim 18, wherein the FXS signal unit sensing a loop current to detect the off-hook state.
